(19) United States
(12) Patent Application Publication
(10) Pub. No.: US 2010/0127199 A1
(43) Pub. Date: May 27, 2010

(54) Valve

(76) Inventor: Thomas Hannewald, Griesheim (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/593,185

(22) PCT Filed: Feb. 11, 2008
(86) PCT No.: PCT/EP08/51589

§ 371 Date: Sep. 25, 2009

(30) Foreign Application Priority Data
Mar. 26, 2007 (DE) 10-2007-014-373.9

(51) Int. Cl. F16K 31/44

(52) U.S. Cl. 251/213

(57) ABSTRACT

A valve having a housing with at least one entry and at least one exit provided on the outer casing of the housing for a flow medium. The housing has a flow space, in which a drive element is centrally and rotatably supported, the rotational axis thereof running perpendicular to the at least one entry and the at least one exit. Between the drive element and the housing, at least one endless strip is provided parallel to the rotational axis of the drive element, the length thereof extending over the at least one entry and the at least one exit. The drive element is connected to a drive and can guide the at least one endless strip in the flow space along the housing during operation. The valve is used as a throttle element for motor vehicles having diesel engines.

### PRIORITY CLAIM

This is a U.S. national stage of application No. PCT/EP2008/051589, filed on 2 Nov. 2008, which claims Priority to German Application No.: 10 2007 014 373.9, filed: 26 Mar. 2007 the contents of both being incorporated herein by reference.

### BACKGROUND OF THE INVENTION

1. Field of the Invention

The invention relates to a valve and to the use of the described valve.

2. Prior Art

Valves are known. DE 102 51 384 A1 describes a valve that is composed of a housing having a valve seat for a rotatably mounted flap on a drive shaft. A first piston sealing ring and a second piston sealing ring are arranged in an encircling groove around an outside of the flap. A disadvantage of said valve is that the flap must be designed and aligned in a relatively complex manner to obtain a desired sealing action. Furthermore, the production of the flap is relatively complex in structural terms.

### SUMMARY OF THE INVENTION

An object of the invention is to provide a valve in which the disadvantageous alignment of the flap is avoided. The invention is further based on creating a special use of the valve.

The valve comprises a housing having at least one inlet E, arranged on an outer casing of the housing for the medium to be conveyed and at least one outlet A, arranged on the outer casing of the housing for the medium to be conveyed. The housing has, at the inside, a flow chamber, in which a valve drive element is rotatably centrally mounted in the flow chamber. A rotational axis D of the drive element runs perpendicular to the at least one inlet E and perpendicular to the at least one outlet A. An endless belt is arranged parallel to the rotational axis D of the drive element between the drive element and the housing, the length L of which endless belt extends over the at least one inlet E and the at least one outlet A, by which the drive element is connected to a drive. In operation, the at least one endless belt is guided along the housing in the flow chamber. For most applications, it is sufficient to provide one inlet E, one outlet A, and one endless belt. As flow media, use is made for example of gases or liquids. The drive element is generally designed in the form of a roller and may for example be composed of solid material. Said drive element may be of single-part or multi-part design. The at least one endless belt has corresponding elastic properties, which may be determined by an engineer. Here, as an endless belt, use is made of an endless belt composed of plastic. The length L of the at least one endless belt extends over the at least one inlet E and the at least one outlet A, such that it is possible for the at least one inlet E or the at least one outlet A to be completely covered by the at least one endless belt, such that it is possible for the at least one inlet E or the at least one outlet A to be closed off by at least one endless belt. The drive is generally an electric motor which is arranged on gearing stages. It has surprisingly been found that it is possible to dispense entirely with the provision of a flap if the at least one inlet E or the at least one outlet A is opened and closed by at least one endless belt. It is therefore possible to dispense with the disadvantageous alignment of a flap in the housing of the valve. To set the respective position of the at least one endless belt during operation, it is necessary merely to guide the at least one endless belt along the housing in the flow chamber, with the rotational movement being imparted by the drive. This may advantageously take place in a simple manner.

According to one preferred embodiment of the invention, the longitudinal axes of the at least one inlet E and of the at least one outlet A have a common point of intersection on the rotational axis D of the drive element. In a special case, it is also possible here for the at least one inlet E and the at least one outlet A to have a common longitudinal axis. This has the advantage that the at least one inlet E and the at least one outlet A are arranged at the same level, advantageously resulting in a compact design of the valve.

According to a preferred embodiment of the invention, a tubular part is provided as the housing. This advantageously facilitates the production of the valve.

According to a further preferred embodiment of the invention, the drive element has projections on its outer side and the at least one endless belt has openings, with the projections and the openings being of complementary design and arrangement to one another. The outer side of the drive element is the side facing toward the inside of the housing of the valve. As a result of the arrangement of the projections and of the openings, it is possible for the drive element to be in engagement with the at least one endless belt, such that the at least one endless belt is guided in a particularly reliable fashion in the flow chamber.

According to a further preferred embodiment of the invention, the drive element has, on its outer side, a coating which increases the adhesion between the drive element and the at least one endless belt. Here, said coating may be composed of a rubber mixture. The at least one endless belt can be guided in the flow chamber without problems in this way too.

A further preferred embodiment of the invention provides that the at least one endless belt is guided, by at least one end side, in at least one guide. In this way, it is ensured that the longitudinal axis of the at least one endless belt does not become displaced even after relatively long periods of operation, and therefore reliable operation of the valve is ensured after relatively long periods of operation. Here, it is particularly advantageous if the at least one endless belt is guided at the two end sides in each case one guide.

According to a further preferred embodiment of the invention, an endless belt composed of sheet metal is provided as the at least one endless belt. In this way, the valve can be operated without problems even at relatively high temperatures.

The subject matter of the invention is also the use of the valve as a throttle element for motor vehicles with diesel engines. Motor vehicles with diesel engines have throttle elements by means of which a vacuum can be generated in the intake pipe. Said throttle elements are preferably of the simplest possible design. On account of the compact design of the valve, the valve may be used as a throttle element for motor vehicles with diesel engines, with the generation of a vacuum being ensured in a relatively simple manner. It is possible here to dispense entirely with the complex alignment of valve flaps.

### BRIEF DESCRIPTION OF THE DRAWINGS

The invention will be explained in more detail and by way of example below on the basis of the drawings.

FIG. 1a), is a first embodiment of the valve in an open state;

FIG. 1b), is a cross section of the first embodiment of the valve of FIG. 1a in the open state;

FIG. 1c), is the first embodiment of the valve in a closed state;

FIG. 1d), is a cross section of the first embodiment of the valve of FIG. 1c valve in the closed state;

FIG. 1e) is a perspective view of the valve of FIGS. 1a-1d with one half of the housing removed;

FIG. 2a), is a second embodiment of the valve in an open state;

FIG. 2b), is a cross section of the valve of FIG. 2a in the open state;

FIG. 2c), is the second embodiment of the valve in a closed state;

FIG. 2d), is a cross section of the valve in FIG. 2c in the closed state;

FIG. 2e) is a perspective view of the second embodiment of the valve with one half of the housing removed;

FIG. 3a), is the third embodiment of the valve in an open state.

FIG. 3b), is a cross section of the third embodiment of FIG. 3a in the open state.

FIG. 3c), is the third embodiment of the valve in a closed state.

FIG. 3d), is a cross section of the third embodiment of FIG. 3a in a closed state.

FIG. 3e) is a perspective view of the third embodiment of the valve with one half of the housing removed.

### DETAILED DESCRIPTION OF THE PREFERRED EMBODIMENTS

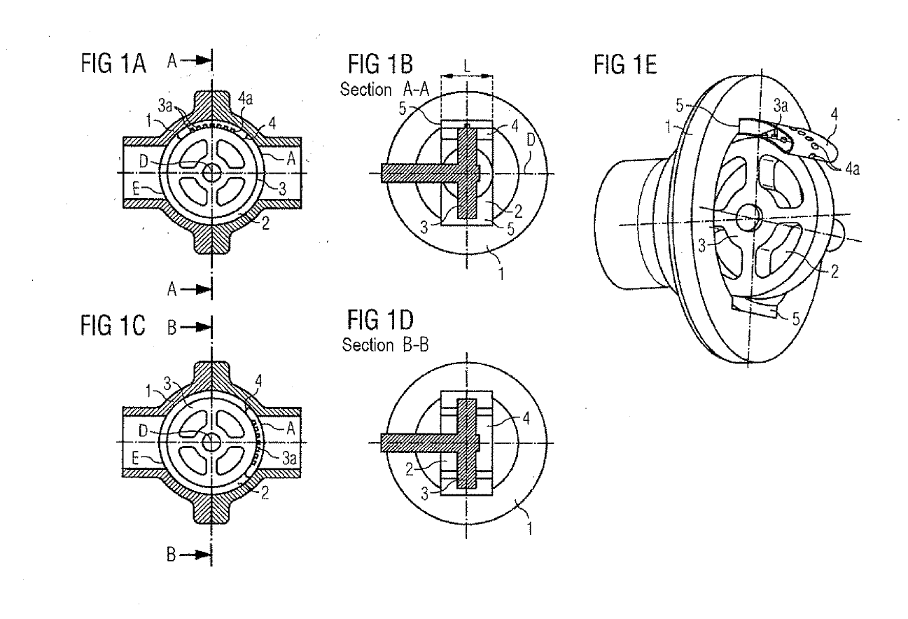

FIG. 1a) is a first embodiment of a valve in the open state in longitudinal section. The valve is composed of a housing 1 having an inlet E, arranged on the outer casing of the housing 1, for the medium to be conveyed and an outlet A, arranged on the outer casing of the housing 1, for the medium to be conveyed. The housing 1 has, at its inside, a flow chamber 2 in which a drive element 3 is rotatably mounted centrally. A rotational axis D, is preferably perpendicular to drive element 3, the inlet E, and the outlet A. An endless belt 4 is arranged parallel to the rotational axis D of the drive element 3 between the drive element 3 and the housing 1. The drive element 3 is connected to a drive (not illustrated) which sets said drive element 3 in rotational motion. As a result of the rotational movement, during operation, the endless belt 4 is guided along the housing 1 in the flow chamber 2. The inlet E and the outlet A have a common longitudinal axis. Inlet E and outlet A are therefore situated at the same level to provide a compact design of the valve. The drive element 3 has projections 3a on its outer side. The endless strip 4 has openings 4a, with the projections 3a and the openings 4a being of complementary design and arrangement to one another. In this way, the endless belt 4 and the drive element 3 are in engagement with one another,

FIG. 1b) illustrates the valve in FIG. 1a) in cross section. The endless belt 4 has a width L which extends over the inlet E and the outlet A (not illustrated). The width L is sufficiently large so that the endless belt 4 can close off both the inlet E and also the outlet A. The endless belt 4 is guided by guide 5.

FIG. 1c) illustrates the valve in longitudinal section in the closed state. Outlet A of the valve is blocked by the endless belt 4 such that the medium to be conveyed cannot emerge out of the valve at the outlet A. The position illustrated in FIG. 1c) is reached by rotating the drive element 3 clockwise by 90° proceeding from the position illustrated in FIG. 1a).

FIG. 1d) illustrates the valve in the closed position according to section B-B in FIG. 1c). The drive element 3 is in contact with a drive (not illustrated) which drives the drive element 3.

FIG. 1e) is a perspective view of the first embodiment of the valve, with a view into the flow chamber 2 in the open position. The endless belt 4 is guided at the two end sides by guide 5.

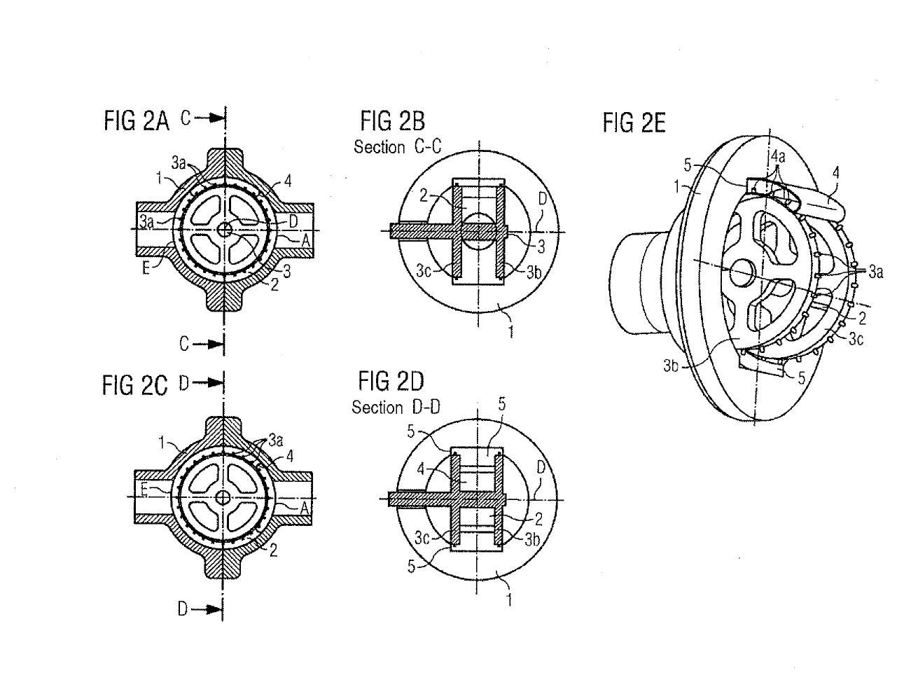

FIG. 2a) illustrates a second embodiment of the valve in the open position in longitudinal section.

FIG. 2b) illustrates the second embodiment of the valve according to section C-C in FIG. 2a).

FIG. 2c) illustrates the second embodiment of the valve in longitudinal section in the closed position. In this position, the outlet A is closed off by the endless belt 4. The closed position is of course also attained by virtue of the endless belt 4 closing off the inlet E (not illustrated).

FIG. 2d) illustrates the second embodiment of the valve in cross section according to the section D-D in FIG. 2c).

FIG. 2e) is a perspective view of the second embodiment of the valve in with a view into the flow chamber 2 in the open position. The difference between the first embodiment of the valve according to FIG. 1 and the second embodiment of the valve according to FIG. 2 is the structural design of the respective drive element 3. The contact element 3 has a first part 3b and a second part 3c which each have projections 3a on their outer sides. The projections 3a are placed in engagement with the endless belt 4. This is made possible by means of openings 4a which are of complementary design to the projections 3a and which are arranged in the endless belt 4. In this way, particularly good guidance of the endless belt 4 is obtained, which is particularly advantageously enhanced by the provision of in each case one guide 5.

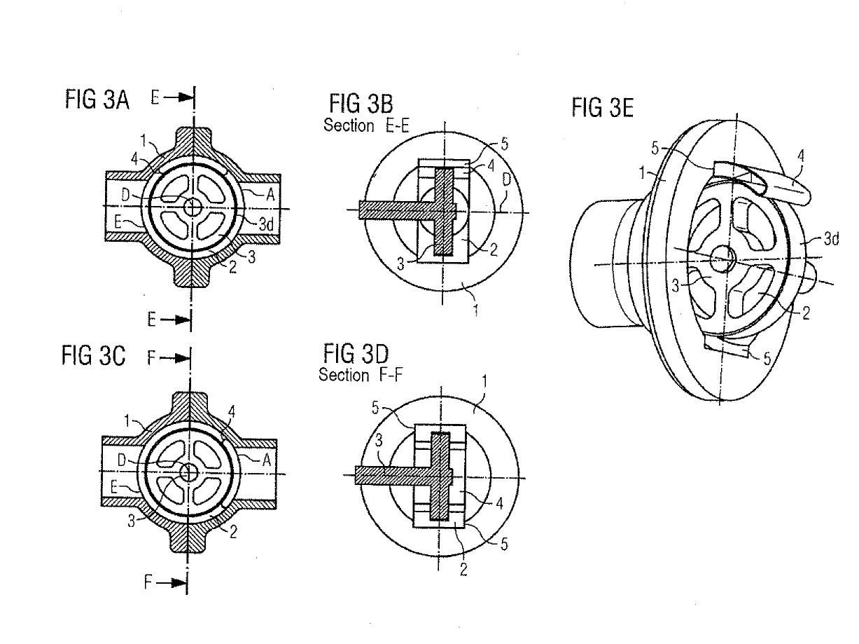

FIG. 3a) is a third embodiment of the valve in the open position in longitudinal section.

FIG. 3b) illustrates the third embodiment of the valve in cross section according to the section E-E in FIG. 3a).

FIG. 3c) shows the third embodiment of the valve in longitudinal section in the closed position.

FIG. 3d) illustrates the third embodiment of the valve in the closed position according to the section F-F in FIG. 3c).

FIG. 3e) is a perspective view of the third embodiment of the valve in with a view into the flow chamber 2 in the open position. The difference between the third embodiment of the valve according to FIG. 3 and the first embodiment of the valve according to FIG. 1 and the second embodiment of the valve according to FIG. 2 lies in the design of the drive element 3 and of the endless belt 4. The drive element 3 has, on its outer side, a coating 3d which increases the adhesion between the drive element 3 and the endless belt 4. The coating is preferably composed, of a rubber mixture. An arrangement of projections and openings is therefore dispensed with in the third embodiment of the valve. The movement of the endless belt 4 takes place here exclusively as a result of the friction generated between the endless belt 4 and the drive element 3. As an endless belt 4, it is particularly advantageously to provide an endless belt composed of sheet metal.

The valve is particularly advantageously suitable as a throttle element for motor vehicles with diesel engines.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A valve comprising:
a housing having an outer casing with at least one inlet and at least one outlet and an inner area having a flow chamber between the at least one inlet and the at least one outlet;
a first drive element rotatably mounted in the flow chamber having a rotational axis perpendicular to at least one of the at least one inlet and the at least one outlet; and
an endless belt arranged between the first drive element and the housing parallel to the rotational axis, a width of the endless belt being sufficiently large to extend over at least one of the at least one inlet and the at least one outlet,
wherein the first drive element is configured to drive the at least one endless belt along in the flow chamber to at least partially close at least one of the at least one inlet and the at least one outlet.

10. The valve according to claim 9, wherein longitudinal axes of the at least one inlet and the at least one outlet have a common point of intersection on the rotational axis of the drive element.

11. The valve according to claim 9, wherein the housing is a tubular part.

12. The valve according to claim 9, wherein
the first drive element comprises a plurality of projections arranged on its outer surface, and
the at least one endless belt comprises a plurality of openings, the plural openings configured to mate with the plural projections.

13. The valve according to claim 9, wherein the first drive element comprises a coating on its outer surface configured to increase adhesion between the first drive element and the at least one endless belt.

14. The valve according to claim 9, wherein the at least one endless belt is guided in at least one guide defined by the housing.

15. The valve according to claim 9, wherein the at least one endless belt is at least one of sheet metal and plastic.

16. The valve according to claim 9 wherein the valve is configured as a throttle element for an engine.

17. The valve according to claim 10, wherein the housing is a tubular part.

18. The valve according to one of claims 10, wherein
the first drive element comprises a plurality of projections arranged on its outer surface, and
the at least one endless belt comprises a plurality of openings, the plural openings configured to mate with the plural projections.

19. The valve according to claim 9, further comprising a second drive element rotatably mounted parallel to the first drive element in the flow chamber.

20. The valve according to claim 19, wherein the second drive element is coupled to the first drive element.

21. The valve according to claim 20, wherein
the first drive element comprises a plurality of first projections arranged on a its outer surface,
the second drive element comprises a plurality of second projections arranged on its outer surface, and
the at least one endless belt comprises a plurality of openings, the plural openings configured to mate with the plural first and second projections.

22. The valve according to claim 13, wherein the coating is a rubber mixture.
